(19) United States
(12) Patent Application Publication
(10) Pub. No.: US 2003/0045176 A1
(43) Pub. Date: Mar. 6, 2003

(54) Means having rotatable connector for electrical applicance

(76) Inventor: De-Hao Liu, Taipei Hsien (TW)

Correspondence Address: Alan Kamrath, RIDER BENNETT EGAN & ARUNDEL, LLP, Suite 2000, 333 South Seventh Street, Minneapolis, MN, 55402, US

(21) Appl. No.: 09/990,974

(22) Filed: Nov. 20, 2001

(30) Foreign Application Priority Data
Aug. 29, 2001 (TW) 090214749

(51) Int. Cl. H01R 13/502

(52) U.S. Cl. 439/687

(57) ABSTRACT

A means having a rotatable connector for connecting with an electrical appliance includes a casing for containing a circuit device and the connector therein; wherein the connector is axial-pivotally coupled to the casing. The present invention is to provide a means having rotatable connector with which connecting to a side of the computer that can be adjusted to avoid hindering the further connection of other connectors. Also the present invention is to enable the means having different functional configurations together with the rotatable connector.

### BACKGROUND OF THE INVENTION

1. Field of the Invention

The present invention relates to a means having a connector, particularly to have a rotatable connector so that the connector will not block or hinder the connection between two electrical appliances.

2. Description of Related Art

Nowadays, because of the enormous and different requirements in the INTERNET communication, users will have to use a lot of different and auxiliary devices, for example an ID identification device, a radio transceiver, an infrared transceiver, to fulfill the diversity of needs. In order to accomplish the requirement, normally there are a lot of sockets in the rear side of the computer so as to enable he user to connect to different electrical appliances. However, it is well known that once different appliance is required, a lot of cables will be hung at the rear of the computer and the cables are easily tangled with one another. Moreover, when the plugs of the cables are connected to the sockets of the computer, some of the connected plugs might hinder the further connection of other plugs.

Therefore, it is an objective of the invention to provide an improved connector to mitigate and/or obviate the aforementioned problems.

### SUMMARY OF THE INVENTION

The main object of the present invention is to provide a means having rotatable connector with which connecting to a side of the computer that can be adjusted to avoid hindering the further connection of other connectors.

Another objection of the present invention is to enable a means to have different functional configurations together with the rotatable connector.

In order to accomplish the foregoing objective, the rotatable connector of the present invention has a casing and a connecting portion rotatably received in the casing and having a connector provided at one end of the connecting portion to connect to a plug and a slit defined in the other end for allowing wires of the connector to extend through the casing to connect to the circuit device of the computer.

Other objects, advantages and novel features of the invention will become more apparent from the following detailed description when taken in conjunction with the accompanying drawings.

### BRIEF DESCRIPTION OF THE DRAWINGS

FIG. 1 is a perspective view of the connector in accordance with the invention;

FIG. 2 is an exploded perspective view of the connector in FIG. 1;

FIG. 3 is a side plan view in partial section showing the connection between the casing and the connecting portion;

FIG. 4 is a perspective view of another embodiment of the present invention, wherein the connector has ports provided at a side face of the casing;

FIG. 5 is a perspective view of still another embodiment of the present invention, wherein the connector has a transceiver mounted therein; and

FIG. 6 is a perspective view of another embodiment of the present invention, wherein the connector has a phone line adapter mounted at the side face of the casing.

### DETAILED DESCRIPTION OF THE PREFERRED EMBODIMENT

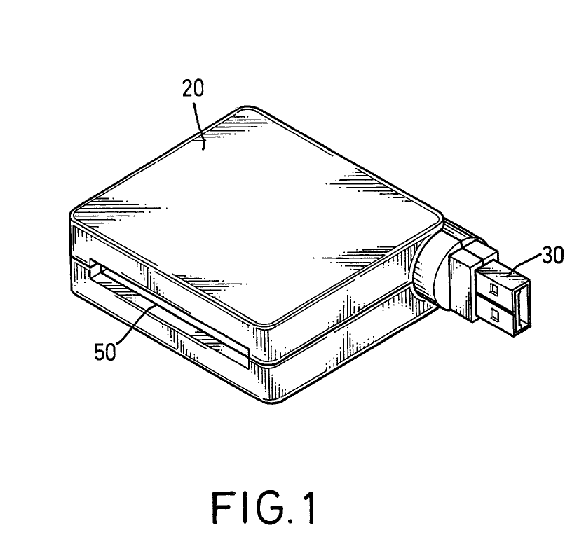

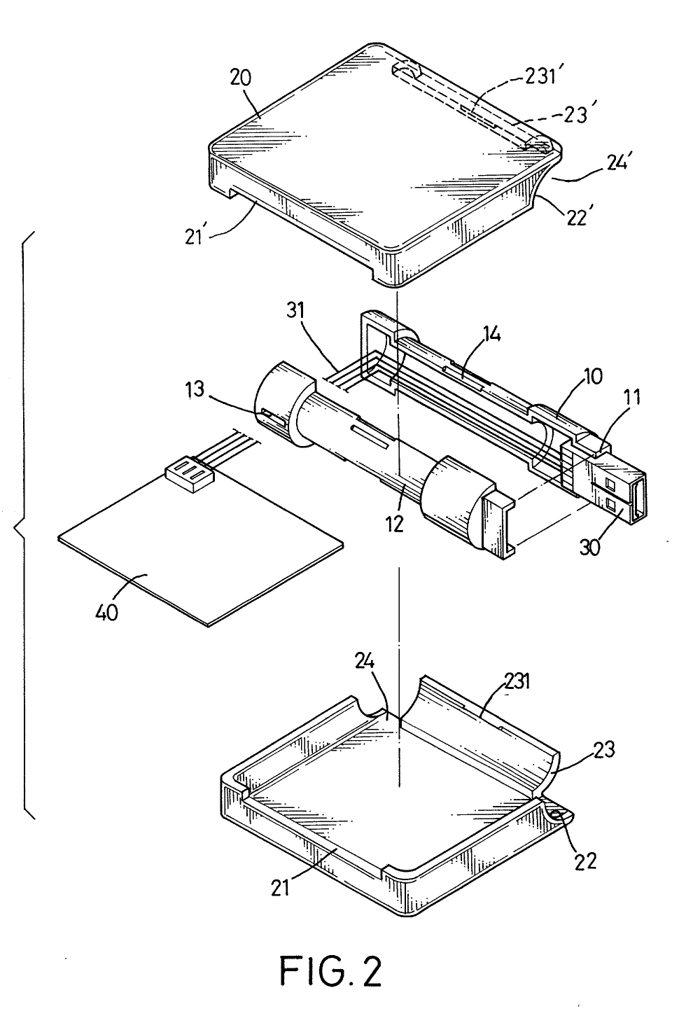

With reference to FIGS. 1 and 2, the means having rotatable connector in accordance with the present invention has a casing (20), a connecting portion (10), a connector (30) and a circuit device (40).

The casing (20) is composed of two halves and defines a space (not numbered) between the two halves. The lower half has a cutout (21) defined in a side face of the lower half. Two arcuate sides (22) are respectively formed on two adjacent corners of the lower half and an arcuate plate (23) extends out from a side face of the lower half opposite to the cutout (21) and between the two arcuate sides (22). A wedge (231) is formed on the arcuate plate (23). Two notches (24) are respectively formed on two adjacent corners of the lower half of the casing (20). The upper half of the casing (20) corresponds to the lower half of the casing (20), which means that the upper half of the casing (20) has a cutout (21′) defined in a side face of the lower half. Two arcuate sides (22′) are respectively formed on two adjacent corners of the lower half and an arcuate plate (23′) extends out from a side face of the lower half opposite to the cutout (21′) and between the two arcuate sides (22′). A wedge (231′) is formed on the arcuate plate (23). Two notches (24) are respectively formed on two adjacent corners of the lower half of the casing (20).

The connecting portion (10) has a securing seat (11), a circular portion (12) and a slit (13). The securing seat (11) is formed at one end of the connecting portion (10) and has, for example, a connector (30) securely formed on the securing seat (11) for connecting to other electrical appliance. The circular portion (12) is formed on a mediate portion of the connecting portion (10) and has recesses (14) peripherally defined in the circular portion (12). A slit (13) is defined at one end opposite to the end where the connector (30) is mounted. The connector (30) has cables (31) which can be received in the connecting portion (10) and extend out of the connecting portion (10) from the slit (13) to connect to a circuit device (40) received between the two halves of the casing (20). The connector (30) may also be, for example, an universal serial bus (USB) so as to connect with an electrical appliance, such as a laptop computer, personal digital assistant (PDA) or the like.

Due to the cutouts (24,24′) and the arcuate sides (22,22′), the connecting portion (10) can be received between the upper and lower halves of the casing (20).

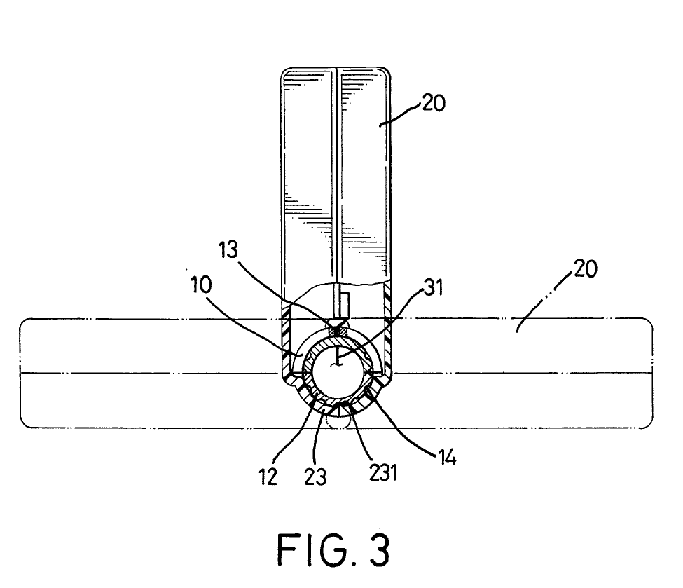

With reference to FIGS. 1 to 3, as previously described, the connecting portion (10) is rotatably received in the casing (20), therefore, when the two halves of the casing (20) are assembled, the connecting portion (10) is received between a space defined by the arcuate sides (22,22′), the arcuate plates (23,23′). After the connecting portion (10) is received between the two halves of the casing (20), the wedges (231,231′) are inserted into an appropriate recess (14) in the circular portion (12) to confine the rotational movement of the connecting portion (10), which finishes the assembly of the rotatable connector of the present invention. Before the wedges (231,231′) are inserted into one of the recesses (14), the circular portion (12) is free to rotate, such that the connector (30) is able to rotate freely to the best orientation for further connection to another electrical appliance. The circuit device (40) in this embodiment is configured for a card receiver (50), providing the function relating to an information input or output as to identify an authorized user for accessing information from the electrical appliance.

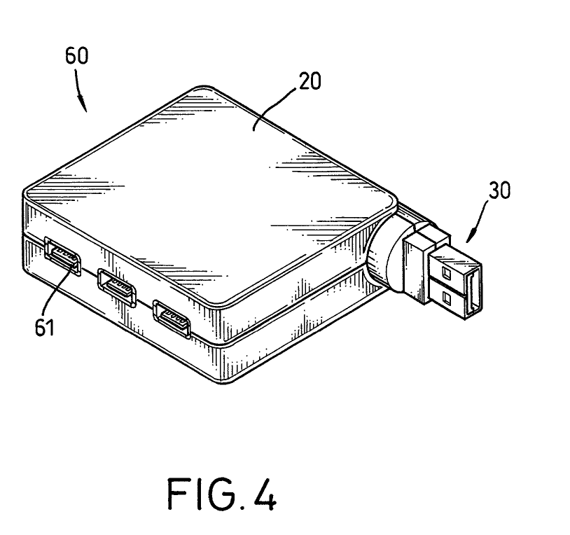

With reference to FIG. 4, the circuit device (40) may be designed as an adapter (60) having multiple ports (61) for connection as a HUB.

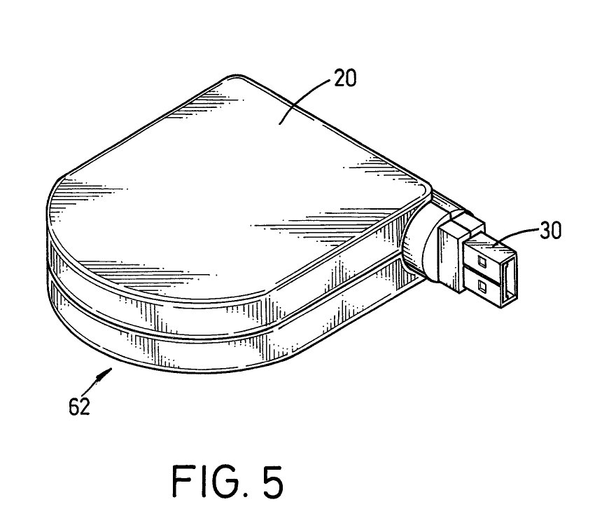

With reference to FIG. 5, the circuit device (40) may be a radio frequency (RF) or an infrared ray (IR) transceiver and/or receiver (62).

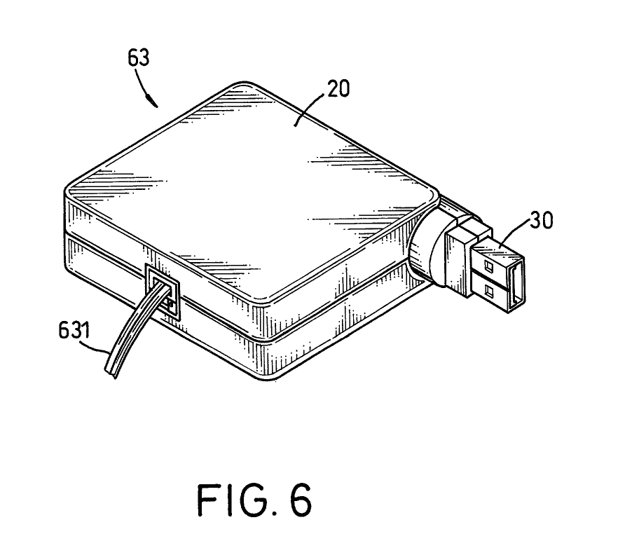

FIG. 6 shows that the circuit device (40) may be designed as a modem (63) and having a port for connection to a network via a phone line (631).

It is to be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A means having a rotatable connector for connecting with an electrical appliance, comprising:
a casing for containing a circuit device and the connector therein;
wherein the connector is axial-pivotally coupled to the casing.

2. The means having a rotatable connector as claimed in claim 1, wherein the casing is composed of an upper half and a lower half; a connecting portion is located between the upper half and the lower half for receiving the connector; and the circuit device electrically connects to the connector.

3. The means having a rotatable connector as claimed in claim 2, wherein a positioning device is located between the connecting portion and the casing such that the casing can be randomly fixed at a desired position.

4. The means having a rotatable connector as claimed in claim 3, wherein the positioning device includes a plurality of wedges disposed on a inner surface of the upper half and the lower half; and a plurality of recesses disposed on a periphery of the connecting portion such that each of the wedges is corresponding to one of the recesses.

5. The means having a rotatable connector as claimed in claim 1, wherein the connector is a universal serial bus.

6. The means having a rotatable connector as claimed in claim 1, wherein the circuit device is configured as a radio frequency transceiver and/or receiver.

7. The means having a rotatable connector as claimed in claim 1, wherein the circuit device is configured as an infrared transceiver and/or receiver.

8. The means having a rotatable connector as claimed in claim 1, wherein the circuit device is configured as a modem having a port for connecting to a network.

9. The means having a rotatable connector as claimed in claim 1, wherein the circuit device is configured as an adapter having a plurality of ports for being further connected.

10. A means for communicating with a computer system, comprising:
a casing for containing a connector therein;
wherein the connector is axial-pivotally coupled to the casing via a positioning device and connected with the computer system, such that the casing can be fixed at a desired position.

11. A connector for connecting with a electrical appliance, comprising:
a positioning device; and
a circuit device for signals and information processing;
wherein the connector is rotatable in an axial direction which can be fixed at a desired position.
